(19) United States
(12) Patent Application Publication
(10) Pub. No.: US 2010/0017794 A1
(43) Pub. Date: Jan. 21, 2010

(54) OPERATING SYSTEM PATCH METADATA SERVICE AND PROCESS FOR RECOMMENDING SYSTEM PATCHES

(75) Inventors: Ian R. Waters, Santa Cruz, CA (US); James Ozone, Ashland, OR (US)

Correspondence Address: BAKER & MCKENZIE LLP;PATENT DEPARTMENT, 2001 ROSS AVENUE, SUITE 2300, DALLAS, TX, 75201, US

(73) Assignee: Terix Computer Company, Inc. d/b/a Terix Computer Service, Sunnyvale, CA (US)

(21) Appl. No.: 12/404,205

(22) Filed: Mar. 13, 2009

Related U.S. Application Data
(60) Provisional application No. 61/036,846, filed on Mar. 14, 2008.

(51) Int. Cl. G06F 17/30; G06F 7/00; G06F 9/44

(52) U.S. Cl. 717/171; 707/10; 707/E17.032; 707/E17.044; 707/104.1

(57) ABSTRACT

A system for providing computer operating system updates includes a service provider facility including a service provider server and a patch database storing patch metadata related to the computer operating system updates, a customer facility including a customer server and at least one operating system node, and an original equipment manufacturers facility communicatively coupled to the customer facility, wherein the customer server accesses a list of available computer operating system updates through the service provider server based upon a customer's subscription with the service provider to download the computer system updates from the original equipment manufacturers facility to the at least one operating system node.

### CROSS-REFERENCES TO RELATED PATENT APPLICATIONS

The present application claims priority under 35 U.S.C. §119(e) to Provisional Application No. 61/036,846, filed on Mar. 14, 2008, which is incorporated herein by reference in its entirety as if set forth in full.

### BACKGROUND

1. Technical Field

The embodiments described herein relate to systems and methods for providing an intelligent database capable of informing customers of available system upgrades and patches, customizing patch sets, and recommending patches to be installed based on data uploaded from the client node.

2. Related Art

Traditionally, companies task sections of their Information Technology (IT) department to research and analyze updates and patches for their operating systems. The updates and patches are provided by the Original Equipment Manufacturer (OEM) who originally provided the operating systems to their customers. When downloaded, these updates and patches may cause problems in the system operations, and may, if not correctly applied, cause problems in the operating systems executing on the customers servers.

Correctly installing and updating patches is a significant burden for the IT department personnel. It constitutes a significant burden on an IT department to research and install the above-described updates and patches. This in turn strains the company's budget due to the time it takes to define and apply appropriate patches and updates, and it may further distract the IT department from supporting important end-user applications.

### SUMMARY

Systems and methods enabling a third-party service provider to maintain a system that collects metadata about available operating system updates and patches, stores the metadata in a database, and recommends patches to be installed on its customers' systems based on the customers' subscription service and data received from the client node are described herein.

Applications running on the customers' servers are operable to determine available updates and patches specific to the customers' operating systems from the third-party service provider, compares the available updates and patches with what is currently installed, and then downloads chosen patches from the OEM patch repository using the end user credentials of the customers' IT personnel, and spools them into a local repository. The patches are retrieved from the local repository and then installed onto the target node.

The described systems and methods enable customers to free themselves from direct management of the patch-management process, and allows the specialist service provider to use its specialized knowledge to efficiently and securely apply patches and updates to the customers' platform operating systems. By centralizing this patch and update management process at the service provider, the service provider achieves economies of scale, thereby placing the service provider in a position to apply the best practices for patch and update management and to alert its customers of observed issues with installed patches.

Further, by inclusion of a local repository at the customers' sites, the customer is able to manage a roll-back of updates from any given point in time within the lifespan of their repository, particularly in those instances in which the service provider or customer observes a problem in the most recent patch or update downloaded from the OEM site.

These and other features, aspects, and embodiments are described below in the section “Detailed Description.”

### BRIEF DESCRIPTION OF THE DRAWINGS

Features, aspects, and embodiments are described in conjunction with the attached drawings, in which:

FIG. 1 is a schematic diagram of an exemplary facility according to one embodiment.

### DETAILED DESCRIPTION

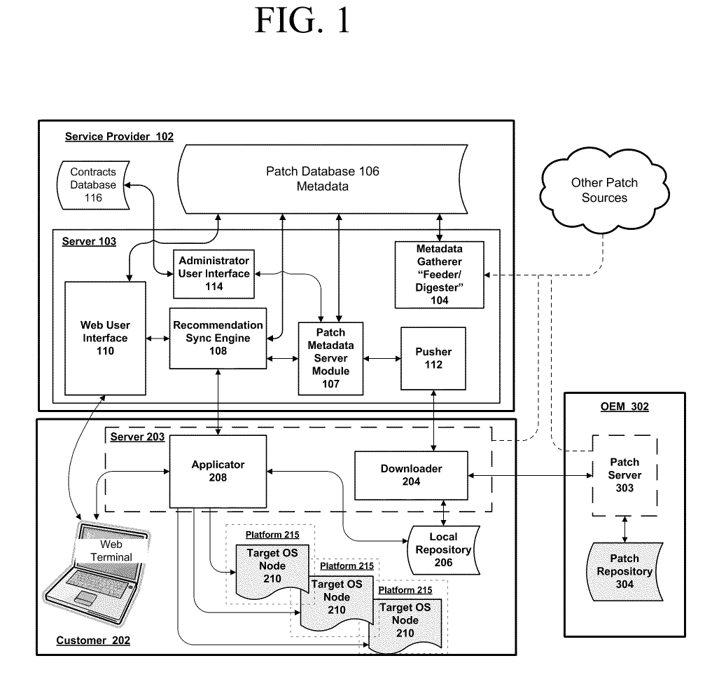

FIG. 1 is a schematic diagram of an exemplary facility according to one embodiment. In FIG. 1, a service provider facility 102 can include a server 103 (or multiple servers in communication) that is operable, and gathers metadata regarding available operating system updates and patches. For example, the metadata can be gathered using a computer process 104 that can collect data about available vendor updates and patches from various sources including, but not limited to, contracted customer servers 203 and vendor patch servers 303. Accordingly, the process 104 can store the received metadata in a patch metadata database 106.

Access to patch data can be based upon the customer's defined patch subscriptions, where those subscriptions are communicated to and known by the service provider 102. For example, a subscription can include patches for a defined vendor (e.g., Sun, IBM), a certain operating system or other software product family (e.g., Solaris, xxxxx), a revision level for the software product, and an architecture (e.g., sparc, x86_{—}32/64, risc) for which the patches are relevant. Accordingly, this subscription information can be stored in the service provider's contracts database 116, and can be managed by the administrator user interface 114 that operates on the services provider's server(s) 103.

In FIG. 1, when patch metadata is requested by the customer's downloader application 204, the pusher application 112 can provide the customer's information to a patch metadata server module 107. When the metadata server module 107 receives customer information from either the pusher application 112 or the recommendation engine 108, the server module 107 can communicate with the administrator user interface 114 to determine which patch families the user is subscribed to. Next, the patch metadata server module 107 can generate a list of corresponding patches by matching the customer's subscription service to available patch metadata located in the patch metadata database 106. Then, the patch metadata server module 107 can deliver the patch- and update-metadata to the requesting application. Once the metadata pusher application 112 receives the metadata from the patch metadata server module 107, the metadata pusher application 112 can then supply the customer's downloader application 204 with the patch metadata.

In FIG. 1, the customer can maintain a facility 202 with a server or servers 203 that communicate with the service provider server 103 to determine needed patches and updates. Furthermore, a patch server or servers 303 at the OEM 302 can download and install updates and patches to the operating system nodes 210 running on the various hardware platforms 215 operating under the customer's control. Although FIG. 1 shows these elements operating at a single indicated customer “site,” the various system elements operating under customer control may be at one or more sites. Further, although a single customer 202 is shown for purposes of illustrating the system architecture, an effective commercial implementation can include a service provider 102 servicing multiple customers 202 with the service provider's patch and update services.

In FIG. 1, the customer server 203 can run a downloader application module 204, which is located “on-site,” but which is provided by the service provider. For example, the application 204 can be run on a system 203 that manages a local patch repository 206 for the customer 202. The downloader application 204 can access a list of available patch metadata through the metadata pusher application 112, and can receive a list of patches. More generally, the downloader application 204 can obtain metadata describing available software updates and patches that should be in the local patch repository 206 based on the user's subscriptions to variations of the OEMs' patch families. In addition, there may be multiple OEMs 302 from which the customer 203 subscribes to patches and updates, depending on the various operating system nodes 210 that the customer 202 operates on its multiple platforms 215.

The downloader 204 can compare the list of available patches and updates (the metadata downloaded from the pusher application 112) with what is in the local repository 206, and can determine which patches need to be downloaded. It may not be necessary for the service provider 102 to know what patches are in the local repository 206, as this can be managed by the downloader application 204. Next, the downloader 204 can download the patches from the OEM patch repository 304 using the customer's credentials for downloading patches. For example, the customer's credentials can be stored at the customer's site, and can be provided to the OEM patch repository 304 as a command line argument. Then, these patches can be spooled to the local repository 206, and metadata files about the patches can be created and stored in the local patch repository 206.

Patches and updates can be downloaded and stored permanently or long-term in the local repository 206 so that the user may recall previously downloaded patches and apply them to current systems even if the recalled patches are not the most current patches in the repository 206. Accordingly, the pusher 112 and downloader application 204 can provide synchronization between the customer's patch repository and the OEM's available patches (both past and present) so that relevant patches and updates can be recommended via the recommendation engine 108 and then installed on the target systems via the local repository 206.

Also running on the customer server(s) 203 is an applicator application 208, which is a software application provided by the service provider 102, and is responsible for installing patches onto the customer's targeted nodes 210/platforms 215. The applicator 208 can operate in two different modes. For example, one mode can collect patch data from the client node, submit the patch data to the service provider's recommendation engine 108, and retrieve a list of patches to be installed. A second mode can use a named patch set (e.g. a previously defined set or list of patches which the user created using the web user interface 110), and can pull that data from the recommendation engine 108. In either mode, the applicator 208 can retrieve the recommended patches from the local repository 206 and install them on the target node/platforms 210/215. Accordingly, the recommendation engine 108 and applicator 208 can provide synchronization between the installed target node operating systems 210 existing on the customer's servers so that relevant patches and updates can be recommended and downloaded through the downloader application 204.

In FIG. 1, the recommendation engine 108 can be maintained by the service provider 102 and can be responsible for determining which patch sets fit the customer's operating system(s) and can deliver that list to the requesting application. For example, the recommendation engine 108 can communicate with the patch metadata server 107 to create a list of available patches for the customer's subscription service. Here, this list is called a patch set. When the recommendation engine 108 receives system data from the applicator 208, the recommendation engine 108 can determine which patch set fits the customer's needs based on current system subscriptions and the data received from the applicator 208. Then, the recommendation engine 108 can recommend a patch set, and can deliver the list to the applicator 208. When the applicator 208 operates in the second mode, the applicator 208 can deliver the named patch set to the recommendation engine 108, and the recommendation engine can pull that named patch set from the database 106, and pass it back to the applicator 208. For example, the named patch sets used by the applicator 208 can be built or designed using a web user interface 110, which can be maintained by the service provider. Accordingly, the end user can upload data from the client node and generate a patch set from the recommendation engine 108. Then, this patch set can be customized by removing or adding patches to the set. Next, the customized patch set can be given a new name and can be stored in the database 106.

In FIG. 1, when the applicator 208 is run, the applicator 208 can be given the name of the patch set, which can be pulled back from the database 106 by the recommendation engine 108. By using the web user interface 110, the patch sets can be recalled and edited by any member of the company for which the patch set was built. In addition, the web interface 110 may also provide a searchable patch/bug database. Here, this interface can allow for powerful searches against vendor patch/bug data that normally would not be possible.

While certain embodiments have been described above, it will be understood that the embodiments described art by way of example only. Accordingly, the systems, devices, and methods described herein should not be limited based on the described embodiments. Rather, the systems, devices, and methods described here should only be limited in light of the claims that follow when taken in conjunction with the above description and accompanying drawing.

What is claimed is:

1. A system for providing computer operating system updates, comprising:
a service provider facility including a service provider server and a patch database storing patch metadata related to the computer operating system updates;
a customer facility including a customer server and at least one operating system node; and
an original equipment manufacturers facility communicatively coupled to the customer facility,
wherein the customer server accesses a list of available computer operating system updates through the service provider server based upon a customer's subscription with the service provider to download the computer system updates from the original equipment manufacturers facility to the at least one operating system node.

2. A method for updating a computer operating system, comprising:
accessing available computer operating system updates from a service provider facility by a customer facility based upon subscription information of a customer stored in the service provider facility;
comparing computer operating system updates stored in a repository of the customer facility with the available computer operating system updates;
determining which of the available computer operating system updates are required for downloading based upon the step of comparing;
accessing an original equipment manufacturers server based upon credentials of the customer based upon the step of determining; and
downloading at least one of the available computer operating system updates from the original equipment manufacturers server onto at least one operating system node of the customer facility based upon the step of accessing.
